(19) United States
(12) Patent Application Publication
(10) Pub. No.: US 2023/0272241 A1
(43) Pub. Date: Aug. 31, 2023

(54) PHOSPHONIUM-CONTAINING POLYURETHANE COMPOSITIONS

(71) Applicant: Hewlett-Packard Development Company, L.P., Spring, TX (US)

(72) Inventors: Zhang-Lin Zhou, San Diego, CA (US); Xiaoqi Zhou, San Diego, CA (US)

(73) Assignee: Hewlett-Packard Development Company, L.P., Spring, TX (US)

(21) Appl. No.: 18/020,222

(22) PCT Filed: Aug. 28, 2020
(86) PCT No.: PCT/US2020/048427

§ 371 Date: Feb. 7, 2023

(51) Int. Cl. C09D 175/06; C08G 18/42; C08G 18/48; C08G 18/73; C08G 18/38; C08G 18/22; C08G 18/40; D06M 15/579; D06P 5/00; D06P 5/20; D06P 5/30; D06P 1/52

(52) U.S. Cl. CPC C09D 175/06; C08G 18/42; C08G 18/4833; C08G 18/73; C08G 18/388; C08G 18/227; C08G 18/4018; D06M 15/579; D06P 5/002; D06P 5/2005; D06P 5/30; D06P 1/5285; D06M 2101/32

(57) ABSTRACT

The present disclosure describes phosphonium-containing polyurethane compositions, coating compositions, and coated fabric media. In one example, a phosphonium-containing polyurethane composition can include an aqueous liquid vehicle and polyurethane particles. The polyurethane particles can include a polyurethane polymer devoid of end cap groups, the polyurethane polymer also including a polyurethane backbone having side chain groups along the polyurethane backbone. The side chain groups can collectively include aliphatic phosphonium salts and polyalkylene oxide groups.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new print media, for example.

### BRIEF DESCRIPTION OF DRAWINGS

FIG. 1 schematically illustrates an example phosphonium-containing polyurethane composition in accordance with the present disclosure;

FIG. 2 schematically illustrates an example coating composition in accordance with the present disclosure;

FIG. 3 schematically illustrates an example coated fabric medium in accordance with the present disclosure; and

FIG. 4 shows a schematic portion of an example phosphonium-containing polyurethane polymer in accordance with the present disclosure.

### DETAILED DESCRIPTION

The present disclosure describes phosphonium-containing polyurethane compositions, coating compositions that include the phosphonium-containing polyurethane and coated fabric media. The coating compositions can provide an ink-receiving surface for printing while also imparting a flame retardant quality to fabric media. In one example, a phosphonium-containing polyurethane composition includes an aqueous liquid vehicle and polyurethane particles. The polyurethane particles include a polyurethane polymer devoid of end cap groups. The polyurethane polymer also includes a polyurethane backbone having side chain groups along the polyurethane backbone. The side chain groups collectively include aliphatic phosphonium salts and polyalkylene oxide groups. In some examples, the aliphatic phosphonium salts can include a trialkylphosphonium salt with three alkyl groups independently including a C1 to C5 straight or branched carbon chain. In further examples, the polyalkylene oxides can include polyethylene oxides, polypropylene oxides, or a combination thereof. In certain examples, the polyalkylene oxides can independently have a number average molecular weight from 500 Mn to 15,000 Mn. In further examples, the polyurethane polymer can have a number average molecular weight from 3,000 Mn to 100,000 Mn. In other examples, the polyurethane particles can have an average particle size of from 25 nm to 3 μm. In some examples, the polyurethane backbone can include polymerized monomers including diisocyanates and diols, wherein the diols collectively include the aliphatic phosphonium salts and polyalkylene oxide groups. In certain examples, the diisocyanates can include 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexane; or a combination thereof.

The present disclosure also describes coating compositions. In one example, a coating composition includes an aqueous liquid vehicle, a polymeric binder, and polyurethane particles. The aqueous liquid vehicle includes water and a surfactant. The polyurethane particles include a polyurethane polymer devoid of end cap groups. The polyurethane polymer also includes a polyurethane backbone having side chain groups along the polyurethane backbone. The side chain groups collectively include aliphatic phosphonium salts and polyalkylene oxide groups. In certain examples, the polymeric binder can include polyacrylate, polyurethane, vinyl-urethane, acrylic urethane, polyurethane-arcylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof. In particular examples, the polymeric binder can include an epoxy resin and the coating composition can also include a curing agent. In further examples, the aliphatic phosphonium salts can include a trialkylphosphonium salt with three alkyl groups independently including a C1 to C5 straight or branched carbon chain; and the polyalkylene oxides can include polyethylene oxides, polypropylene oxides, or a combination thereof independently having a number average molecular weight from 500 Mn to 15,000 Mn.

The present disclosure also describes coated fabric media. In one example, a coated fabric medium includes a fabric substrate and a coating on a surface of the fabric substrate. The coating includes a polyurethane polymer devoid of end cap groups. The polyurethane polymer also includes a polyurethane backbone having side chain groups along the polyurethane backbone. The side chain groups collectively include aliphatic phosphonium salts and polyalkylene oxide groups. In some examples, the aliphatic phosphonium salts can include a trialkylphosphonium salt with three alkyl groups independently including a C1 to C5 straight or branched carbon chain; and the polyalkylene oxides can include polyethylene oxides, polypropylene oxides, or a combination thereof independently having a number average molecular weight from 500 Mn to 15,000 Mn. In further examples, the coating can also include a polymeric binder that includes polyacrylate, polyurethane, vinyl-urethane, acrylic urethane, polyurethane-arcylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof.

It is noted that when discussing the phosphonium-containing polyurethane compositions, coating compositions, and coated fabric media, these discussions can be considered applicable to one another whether or not they are explicitly discussed in the context of that example. Thus, for example, when discussing polyurethane backbones related to the phosphonium-containing polyurethane compositions, such disclosure is also relevant to and directly supported in the context of the coating compositions and coated fabric media, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

The term “phosphonium-containing polyurethane composition” refers to fluid dispersion compositions that include polyurethane particles made of a polyurethane polymer with certain structural characteristics that are described in more detail below. The polyurethane polymer can include a polyurethane backbone having side chain groups along the backbone. The side chain groups can include aliphatic phosphonium salts and polyalkylene oxide groups. Additionally, the polyurethane polymer can be devoid of end cap groups. Fluid dispersions of these polyurethane particles can be used as-is to coat fabric media in some examples, or the fluid dispersions of polyurethane particles can be combined with additional ingredients to make coating compositions for coating fabric media.

The phosphonium-containing polyurethane compositions described herein can be particularly useful for coating print media. The polyurethane can act as a binder. The aliphatic phosphonium salt groups of the polyurethane can impart a flame retardant property to the coating. This can be useful when the polyurethane composition is used to coat fabric media and in other applications where flame retardant capability is desired. Additionally, the polyurethane can act as a fixer for colorants in ink. Cationic materials can fix colorants from certain types of ink. Because the aliphatic phosphonium salt groups are cationic, the polyurethane polymer can also act as a fixer in the same way. In certain examples, the polyurethane composition can be applied to fabric print media and the polyurethane can act as a fixer for inkjet ink. Images printed on such coated fabric media can have excellent image quality and durability while also maintaining good flame retardancy.

The phosphonium-containing polyurethane compositions can also have an unusually high molecular weight compared to other polyurethane polymers. In some examples, polyurethane polymers can be formed by polymerizing diisocyanate monomers and diol monomers. The diisocyanate monomers can include two isocyanate groups that are reactive with hydroxyl groups of the diol monomers. These groups can react to form a urethane linkage. Multiple diisocyanate monomers and diol monomers can link together to form chains of various sizes. In some other types of polyurethane polymers, an end capping monomer can be added at some point during the polymerization process. The end capping monomer can be a monomer with a single reactive group, such as a monoalcohol. When the single reactive group of the end capping monomer links to a polymer chain, the polymerization process stops because the end capping monomer does not include another reactive group that can continue polymerization. However, the phosphonium-containing polyurethane compositions described herein can be devoid of end capping groups. In other words, when the polyurethane polymer is being formed by polymerizing monomers, no monomers having a single reactive group are added. The monomers used in the polymerization can include two or more reactive groups per monomer. This can allow polymer chains to continue to lengthen until a high molecular weight is achieved. Because no end cap groups are present, the polyurethane polymer chains can terminate in reactive groups, such as unreacted isocyanate groups or unreacted hydroxyl groups. However, in practice, the isocyanate groups are sufficiently reactive with water that unreacted isocyanate groups can eventually react with water to form amino groups. The amino groups can sometimes react with other unreacted isocyanate groups to crosslink the polyurethane strands. As a result, in some cases a majority of the polyurethane polymer chains can terminate in hydroxyl groups. In some cases, two ends of a polymer chain can link together to form a loop. In certain examples, the number-average molecular weight of the polyurethane polymer can be from 3,000 Mn to 100,000 Mn.

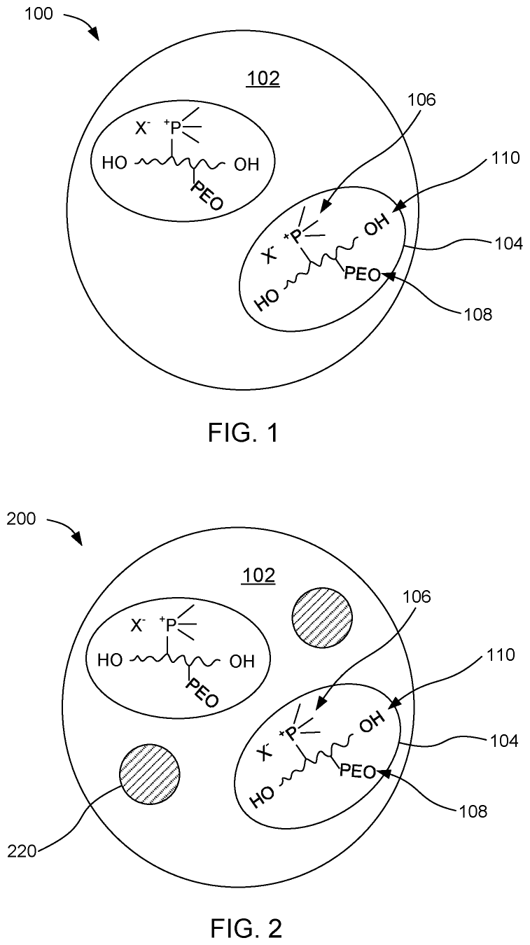

Turning now to more specific detail regarding various phosphonium-containing polyurethane compositions, an example phosphonium-containing polyurethane composition 100 is shown in FIG. 1. The composition includes a liquid vehicle 102 and polyurethane particles 104 dispersed therein. The liquid vehicle can be an aqueous liquid vehicle including water and which may include additional ingredients such as a surfactant, an organic co-solvent, and others. The polyurethane particles can include polyurethane polymers with polyurethane backbones having side chain groups along the polyurethane backbones. The side chain groups include aliphatic phosphonium salts 106 and polyalkylene oxide groups 108. As explained above, the polyurethane polymer can be devoid of end cap groups. Therefore, in some examples, the polyurethane backbones can terminate with unreacted reactive groups that were present on the monomers used to form the polymer. In the example shown in FIG. 1, the polymer chains terminate in unreacted hydroxyl groups 110.

In the example shown in FIG. 1, the polyalkylene oxide 108 is shown schematically as abbreviated PEO, but it is noted that the polyalkylene oxide may be a polyethylene oxide, a polypropylene oxide, or may include a combination polyethylene oxide and polypropylene oxide moieties. Also, in the example shown, a cationic “P” group is shown with multiple methyl groups, but it is understood that in various examples these may be short chain alkyl groups, such as from C1 to C5 branched or straight-chained alkyl. Other variations of these polyurethane backbone pendent side chain groups can also be used, or combinations of polyurethane polymers, or polyurethane polymers with different pendent side groups, etc., can be used, which are not shown specifically in this example. The phosphonium-containing polyurethane polymers are described in more detail below.

In further examples, the phosphonium-containing polyurethane polymers can be incorporated into a coating composition. In some examples, the coating composition can include an additional polymeric binder besides the phosphonium-containing polyurethane. FIG. 2 shows one example coating composition 200 that includes an aqueous liquid vehicle 102, a polymeric binder 220, and polyurethane particles 104 that include aliphatic phosphonium salts 106 and polyalkylene oxide groups 108 as described above.

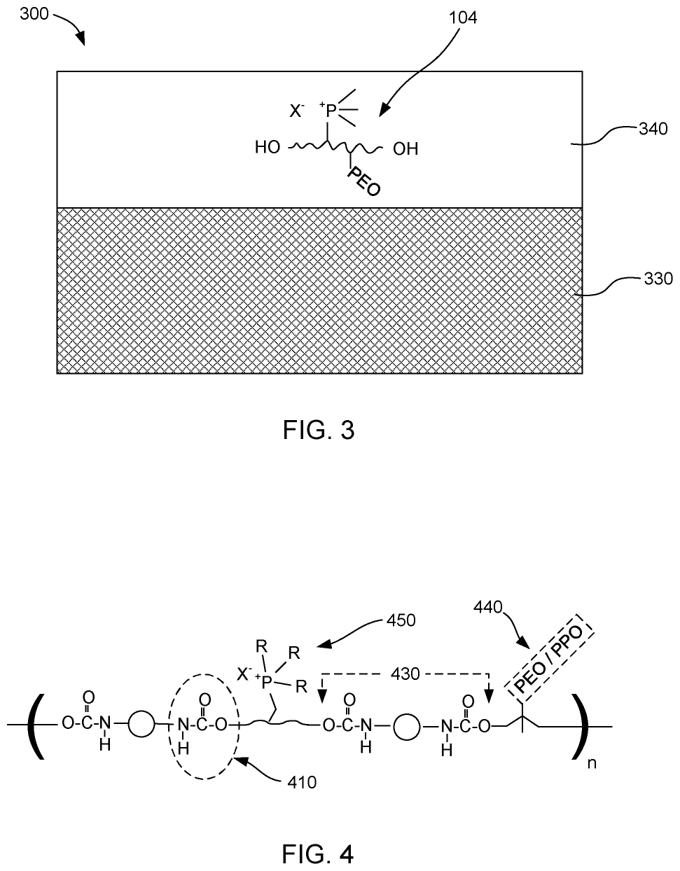

The phosphonium-containing polyurethane compositions can also be coated on fabric print media. FIG. 3 shows a schematic cross-sectional view of one example coated fabric medium 300. The coated fabric medium includes a fabric substrate 330 and a coating 340 on the surface of the fabric substrate. The coating includes a phosphonium-containing polyurethane polymer 104 as described above. The polyurethane polymer includes a polyurethane backbone having side chain groups that include aliphatic phosphonium salts and polyalkylene oxide groups. The polyurethane polymer can be film-forming, so that the polyurethane particles that are present in the liquid coating composition form a film on the fabric substrate after the coating composition dries. In some examples, the polyurethane polymer can form a continuous film as depicted in FIG. 3. In other examples, discrete pockets or regions of the polyurethane polymer can form on fibers of the fabric substrate.

Turning to a more detailed description of the phosphonium-containing polyurethane polymers, FIG. 4 shows a chemical structure of an example phosphonium-containing polyurethane polymer in accordance with the present disclosure. As mentioned above, this polymer can be present in the form of polyurethane particles in the coating compositions described herein. As an initial matter in regard to the example schematic structure shown in FIG. 4, m can be from 1 to 18, from 1 to 14, from 1 to 10, from 2 to 18, from 2 to 10, from 1 to 5, or from 2 to 5, for example. R can independently be straight-chained or branched C1 to C5 or C2 to C5 alkyl, and X can be any counterion suitable for the positively charged phosphorus atom of the phosphonium salt end cap group, such as Cl, Br, I, sulfonate, p-toluenesulfonate, trifluoromethanesulfonate, etc.

The number average molecular weight of the polyurethane polymers present in the polyurethane particles can be from 3,000 Mn to 500,000 Mn, from 10,000 Mn to 400,000 Mn, from 20,000 Mn to 250,000 Mn, from 10,000 Mn to 200,000 Mn, or from 50,000 Mn to 500,000 Mn, as measured by gel permeation chromatography, for example.

The polyurethane particles included in the context of the present disclosure can have a D50 particle size from 25 nm to 3 μm, from 25 nm to 1 μm, from 40 nm to 500 nm, from 60 nm to 300 nm, or from 25 nm to 250 nm, for example. “D50” particle size is defined as the particle size at which about half of the particles are larger than the D50 particle size and about half of the other particles are smaller than the D50 particle size (by weight based on the particle content of the particles being sized). As used herein, particle size with respect to the polyurethane particles can be based on volume of the particle size normalized to a spherical shape for diameter measurement. Particle size information can also be determined and/or verified using a scanning electron microscope (SEM).

With further reference to FIG. 4, several chemical moieties are schematically shown by way of example, including urethane linkage groups 410 (formed from isocyanate groups reacted with any of a number of polyols that may be present). For example, the polyols 420 are shown schematically after polymerization. These polyols can be in the form of polymeric diols or short chained diols that may include pendant polyalkylene oxides and pendant aliphatic phosphonium salts, etc., or other types of polyols. The polyols can be reacted with isocyanates to form the urethane linkage groups. In more specific detail, the urethane linkage groups along a backbone of the polyurethane polymer can be formed by reacting these or other polyols with diisocyanates, which are shown at 430 as a backbone group after reaction with hydroxyl groups of the two adjacent compounds. The diisocyanates, shown as polymerized along the polyurethane backbone, are schematically represented by a circle with isocyanate groups on either side thereof.

In examples herein, there are two types of pendent groups that characterize the polyurethane polymers described herein, which are shown in FIG. 4. These two types of pendent groups include a polyalkylene oxide 440 and an aliphatic phosphonium salt 450. In this figure, “PEO” refers to polyethylene oxide, “PPO” refers to polypropylene oxide, and “PEO/PPO” indicates that the polyalkylene oxide can be polyethylene oxide, polypropylene oxide, or can include both types of monomeric units as a hybrid polyalkylene.

As mentioned above, the polyurethane polymer can be devoid of end cap groups. Accordingly, the ends of the polymer chain can include unreacted functional groups present in the monomers, such as unreacted isocyanate groups or unreacted hydroxyl groups. In some examples, the polyurethane polymer can be polymerized using an excess of the diisocyanate monomers. As mentioned above, unreacted isocyanate groups are likely to eventually react with water to form amino groups. Therefore, in these examples, some of the polyurethane polymer chains can terminate in amino groups. In other examples, the polymer chains can be polymerized using an excess of diol monomers. In these examples, a majority of the polymer chains can terminate in unreacted hydroxyl groups. Because no end capping monomers are added during the polymerization, the polymerization reaction can continue until the polyurethane polymer chains reach a high molecular weight. In some examples, the polymerization reaction can continue until no more monomers are available to attach to the polymer chains. During the polymerization reaction, multiple polymer chains can link together. For example, one polymer chain that terminates in an unreacted isocyanate group can link to a second polymer chain that terminates in an unreacted hydroxyl group. Thus, very high molecular weights can be achieved. In certain examples, some of the polymer chains may also form loops by linking both ends of the chain together.

In accordance with examples of the present disclosure, these and other types of polyurethane particles prepared in accordance with the present disclosure can include polyurethane polymers with an acid number from 0 to 10 mg KOH/g, from 0 to 5 mg KOH/g, or 0 mg KOH/g. The term “acid value” or “acid number” refers to the mass of potassium hydroxide (KOH) in milligrams that can be used to neutralize one gram of substance (mg KOH/g), such as the various polymers disclosed herein. This value can be determined, in one example, by dissolving or dispersing a known quantity of a material in organic solvent and then titrating with a solution of potassium hydroxide (KOH) of known concentration for measurement.

It is noted that the structure shown in FIG. 4 is not intended to depict a specific polymer, but rather to show examples of the types of groups that may be present along the polyurethane backbone of polyurethane polymers present in a polyurethane particle. For example, there may be additional polymerized polymeric diols, polymerized isocyanates, urethane linkage groups, polyalkylene oxides, or even other moieties not shown in this example, such as epoxides, organic acids, etc. provided by other diols. Examples of other types of compounds that can be used include various organic acid diols, C2-C20 aliphatic diols, glycidyl-containing diols to generate epoxy functional groups, functional amine groups derived from isocyanate groups that do not form a urethane linkage group, acid groups introduced from sulfonic acid or carboxylic acid diamines, or the like. These and other types of moieties can be included.

Example diisocyanates that can be used to prepare the polyurethane polymer (used subsequently to form the polyurethane particles) include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexane (H12MDI), etc., or combinations thereof, as shown below. Others can likewise be used alone, or in combination with these diisocyanates, or in combination with other diisocyanates not shown.

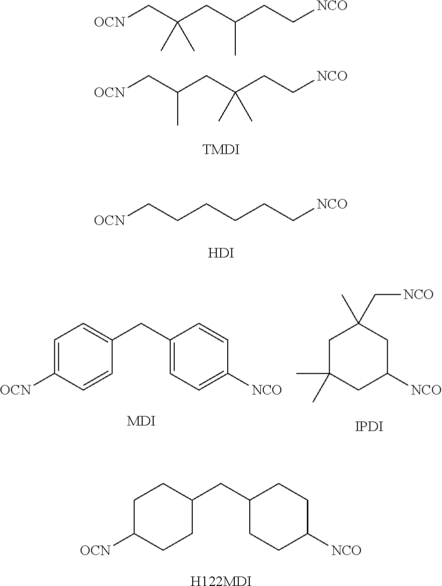

In further detail, diols and/or polyols can be included to react with the isocyanates to form the urethane linkage groups. These alcohols can include the polyalkylene oxide groups and aliphatic phosphonium salts.

As mentioned, polyalkylene oxides can be included, for example, as pendant groups in the form of side chain groups or end cap groups. The polyalkylene oxides can include polyethylene oxide (PEO), polypropylene oxide (PPO), or a hybrid of both PEO and PPO, which includes both types of monomeric units as a hybrid polyalkylene. These polyalkylene oxides can be grafted or copolymerized during formation of a polyurethane pre-polymer to provide polyalkylene oxide moieties along the backbone. The polyalkylene oxide moieties can have a number average molecular weight (Mn) from 200 Mn to 15,000 Mn, from 500 Mn to 15,000 Mn, from 1,000 Mn to 12,000 Mn, from 2,000 Mn to 10,000 Mn, or from 3,000 Mn to 8,000 Mn, which can be measured by gel permeation chromatography.

In further detail, the aliphatic phosphonium salts can be included, for example, as pendant groups in the form of side chain groups. In preparation for incorporating the aliphatic phosphonium salt into the polyurethane backbone of the polyurethane polymer, the aliphatic phosphonium salt can be prepared by the following reaction scheme (Equation 1), which provides a general method of making various aliphatic phosphonium salt-based diols. More specifically, the following is an example reaction of an alkyl phosphine (I) with a halogenated primary alcohol (II) at a high temperature, e.g., 100° C., to give a trialkylphosphonium salt-based alcohol (III)

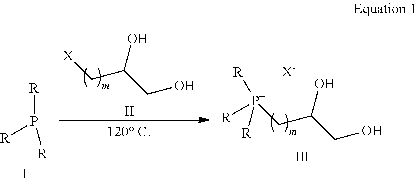

where R can independently be straight-chained or branched C1 to C5 or C2 to C5 alkyl; m can be from 1 to 18, from 1 to 14, from 1 to 10, from 2 to 18, from 2 to 10, from 1 to 5, or from 2 to 5; and X can be any suitable counterion for the positively charged phosphorus atom, such as bromide, chloride, or iodide, sulfonate, p-toluenesulfonate, trifluoromethanesulfonate, for example. Based on the general reaction scheme shown above as Equation 1, large numbers of example aliphatic phosphonium salt-based diols can be synthesized for inclusion as side chain pendant groups along the polyurethane backbone. In accordance with that shown in Equation 1, several example trialkylphosphonium salt-based diols can be formed, as shown below:

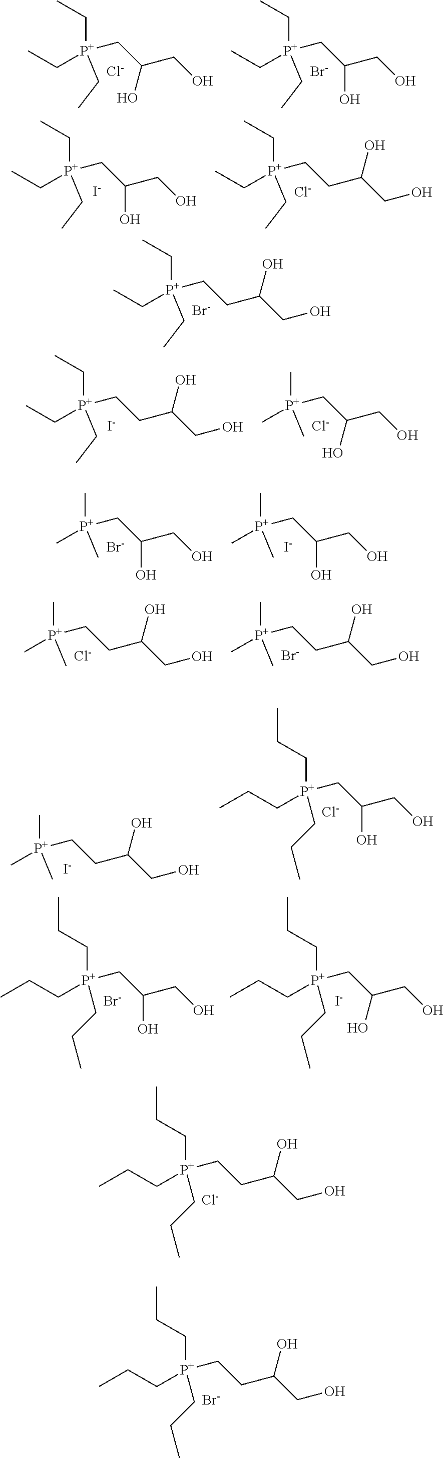

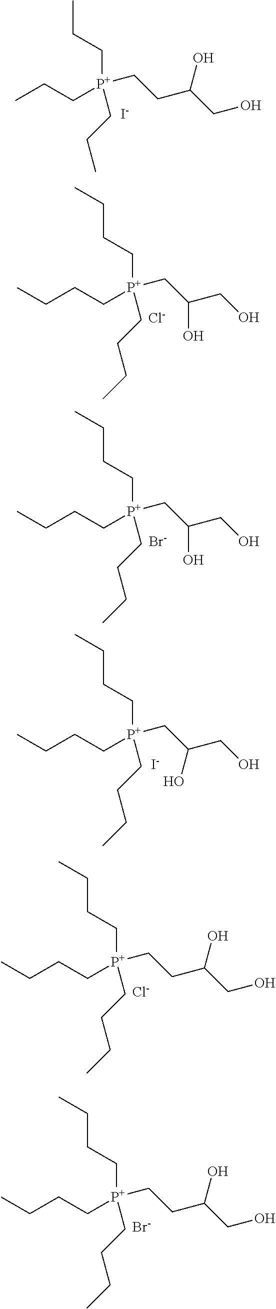

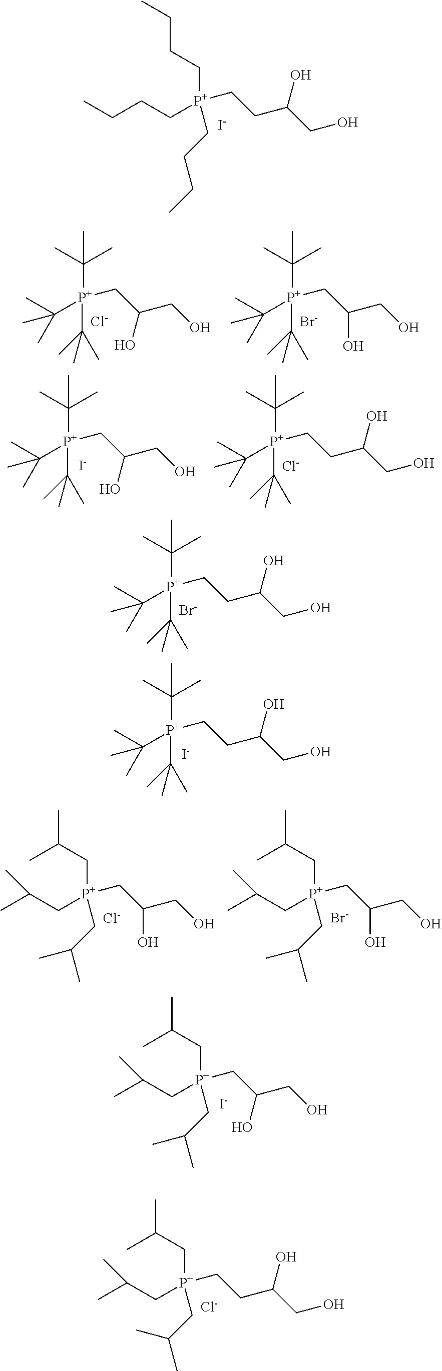

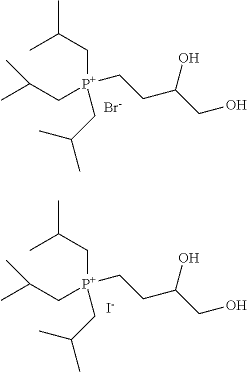 [SMILES: CC(C)C[P+](CCC(O)CO)(CC(C)C)CC(C)C ; [Br-] ; CC(C)C[P+](CCC(O)CO)(CC(C)C)CC(C)C ; [I-]]

In further detail, in some examples, the polyurethane polymers of the polyurethane particles can be prepared with polymeric portions from any of a number of other types of polymeric diols. Example polymeric diols that can be used include polyether diols (or polyalkylene diols), such as polyethylene oxide diols, polypropylene oxide diols (or a hybrid diol of polyethylene oxide and polypropylene oxide), or polytetrahydrofuran. Other polymeric diols that can be used include polyester diols, such as polyadipic ester diol, polyisophthalic acid ester diol, polyphthalic acid ester diol; or polycarbonate diols, such as hexanediol based polycarbonate diol, pentanediol based polycarbonate diol, hybrid hexanediol and pentanediol based polycarbonate diol, etc. Combinations of polymeric diols can also be used to prepare polyurethanes such as polycarbonate ester polyether-type polyurethanes, or other hybrid-types of polyurethane particles. In forming the polymer, the reaction between the polymeric diols and the isocyanates can occur in the presence of a catalyst in acetone under reflux. The resultant polymer may include polymerized polymeric diols and polymerized isocyanates with urethane linkage groups along the polymer. In some specific examples, other reactants may also be used as mentioned (other types of diols, amines, etc.).

The following includes preparative examples that can be used to form polyurethane particles with polyalkylene oxides and/or aliphatic phosphonium salts. These different types of pendant groups are both present on the polyurethane polymer and can both be included as side chain groups. In accordance with this, a preparative reaction process is provided by example, and should not be considered limiting.

In some examples, the polyurethane polymer can be prepared with an NCO/OH ratio from 1.2 to 2.2. In another example, the polyurethane polymer can be prepared with an NCO/OH ratio from 1.4 to 2.0. In yet another example, the polyurethane polymer can be prepared using an NCO/OH ratio from 1.6 to 1.8.

The phosphonium-containing polyurethane can be made in the form of particles dispersed in a liquid vehicle. In some examples, the liquid vehicle can include water. The liquid vehicle can also include additional ingredients, such as surfactants and co-solvents. In certain examples, this composition can be used as-is for coating print media such as fabric print media. In other examples, additional ingredients can be added to make a coating composition. Additional ingredients that may be included in the coating composition can include additional polymers, cross-linking agents, curing agents, inorganic fillers, processing aids such as pH control agents, thickening agents, and others. In certain examples, the coating composition can include the phosphonium-containing polyurethane particles and an additional polymeric binder. In further examples, the coating composition can include the phosphonium-containing polyurethane particles and an additional polymeric binder and the composition can be devoid of inorganic fillers.

The additional polymer that may be included in the coating composition can be selected from a variety of types of polymer. In some examples, the additional polymer can be devoid of phosphonium groups. In certain examples, the additional polymer can be an additional type of polyurethane polymer. In other examples, the additional polymer can be another type of polymer, such as polyacrylate, vinyl-urethane, acrylic urethane, polyurethane-acrylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof.

In one example, the additional polymer included in the coating composition can be a polyacrylate. Example polyacrylate based polymers can include polymers made by hydrophobic addition monomers including, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives may also be useful.

In another example, the additional polymer in the coating composition can include a polyurethane polymer that is different from the phosphonium-containing polyurethane polymer. The additional polyurethane polymer can be hydrophilic. The polyurethane can be formed in one example by reacting an isocyanate with a polyol. Example isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commerically available isocyanates can include RHODOCOAT™ WT 2102 (available from Rhodia AG, Germany), BASONAT® LR 8878 (available from BASF Corporation, N. America), DESMODUR® DA, and BAYHYDUR® 3100 (available from Bayer AG, Germany). In some examples, the isocyanate can be protected from water. Example polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclohexanedimethanol; 1,2,3-propanetriol; 2-ethyl-2-hydroxymethyl-1,3-propanediol; or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having two or more isocyanate functionalities and a polyol having two or more hydroxyl or amine groups. Example polyisocyanates can include diisocyanate monomers and oligomers.

Example secondary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; or combinations thereof. (All of these polyurethanes are available from Alberdingk Boley Inc., North Carolina).

In some examples the additional polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the additional polyurethane can include an aromatic polyether polyurethane, an aliphatic polyether polyurethane, an aromatic polyester polyurethane, an aliphatic polyester polyurethane, or a combination thereof. Example commercially-available polyurethanes can include; NEOPAC® R-9000, R-9699, and R-9030 (available from Zeneca Resins, Ohio), PRINTRITE™ DP376 and SANCURE® AU4010 (available from Lubrizol Advanced Materials, Inc., Ohio), and HYBRIDUR® 570 (available from Air Products and Chemicals Inc., Pennsylvania), SANCURE® 2710, AVALURE® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), SANCURE® 878, SANCURE® 815, SANCURE® 1301, SANCURE® 2715, SANCURE® 2026, SANCURE® 1818, SANCURE® 853, SANCURE® 830, SANCURE® 825, SANCURE® 776, SANCURE® 850, SANCURE® 12140, SANCURE® 12619, SANCURE® 835, SANCURE® 843, SANCURE® 898, SANCURE® 899, SANCURE® 1511, SANCURE® 1514, SANCURE® 1517, SANCURE® 1591, SANCURE® 2255, SANCURE® 2260, SANCURE® 2310, SANCURE® 2725, SANCURE®12471, (all commercially available from Lubrizol Advanced Materials, Inc., Ohio), or combinations thereof.

In some examples, the polyurethane can be crosslinked using a crosslinking agent. In one example, the crosslinking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include BAYHYDUR® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the additional polymer in the coating composition can include an epoxy. The epoxy can be an alkyl epoxy resin, an alkyl aromatic epoxy resin, an aromatic epoxy resin, epoxy novolac resins, epoxy resin derivatives, or combinations thereof. In some examples, the epoxy can include an epoxy functional resin having one, two, three, or more pendant epoxy moieties.

In one example, the epoxy resin can be self-crosslinked. Self-crosslinked epoxy resins can include polyglycidyl resins, polyoxirane resins, or combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resin hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, or combinations thereof.

In addition to the liquid vehicle, phosphonium-containing polyurethane particles, and in some examples the additional polymer and crosslinkers or curing agents, the coating composition can include other solids such as inorganic fillers. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, or combinations or mixtures thereof. In some examples, the inorganic pigment includes a clay or a clay mixture. In some examples, the inorganic pigment includes a calcium carbonate or a calcium carbonate mixture. The calcium carbonate may include ground calcium carbonate (GCC), precipitated calcium carbonate (PCC), modified GCC, or modified PCC, for example. For example, the inorganic pigment may include a mixture of a calcium carbonate and a clay. The particulate fillers can have average particle size ranging from 0.1 μm to 20 μm, with a dry weight ratio of phosphonium-containing polyurethane particles to particulate filler ranging from 100:1 to 1:20, from 50:1 to 10:1, from 20:1 to 5:1, or from 10:1 to 1:1, for example. A specific example of a particulate filler that can be used is NUCAP®, which is available from Kamin, LLC, USA.

In some examples, there are other additives that can be used or included, such as coating composition thickener, such as TYLOSE® HS-100K, available from SE Tylose GmbH & Co. KG, Germany. Surfactant, such as PLURONIC® L61, available from BASF SE, Germany, can also be included. Other commercially-available surfactants that can be used include the TAMOL™ series from Dow Chemical Co., nonyl and octyl phenol ethoxylates from Dow Chemical Co., USA (e.g., TRITON™ X-45, TRITON™ X-100, TRITON™ X-114, TRITON™ X-165, TRITON™ X-305 and TRITON™ X-405) and other suppliers (e.g., the T-DET™ N series from Harcros Chemicals, USA), alkyl phenol ethoxylate (APE) replacements from Dow Chemical Co., Elementis Specialties, and others, various members of the SURFYNOL® series from Air Products and Chemicals, USA, (e.g., SURFYNOL® 104, SURFYNOL® 104A, SURFYNOL® 104BC, SURFYNOL® 104DPM, SURFYNOL® 104E, SURFYNOL® 104H, SURFYNOL® 104PA, SURFYNOL® 104PG50, SURFYNOL® 104S, SURFYNOL® 2502, SURFYNOL® 420, SURFYNOL® 440, SURFYNOL® 465, SURFYNOL® 485, SURFYNOL® 485W, SURFYNOL® 82, SURFYNOL® CT-211, SURFYNOL® CT-221, SURFYNOL® OP-340, SURFYNOL® PSA204, SURFYNOL® PSA216, SURFYNOL® PSA336, SURFYNOL® SE and SURFYNOL® SE-F), CAPSTONE® FS-35 from DuPont (USA), various fluorocarbon surfactants from 3M, E.I. DuPont, and other suppliers, and phosphate esters from Ashland, Rhodia and other suppliers. DYNWET® 800, for example, from BYK-chemie, Gmbh (Germany), can also be used.

The coating compositions described herein can be applied to any print media substrate type using any method appropriate for the coating application properties, e.g., thickness, viscosity, etc. Non-limiting examples of methods include dipping coating, padding, slot die, blade coating, and Meyer rod coating. When the coating composition is dried by removal of water and/or other volatile solvent content, the coating composition can form a coating layer. Drying can be carried out by air drying, heated airflow drying, baking, infrared heated drying, etc. Other processing methods and equipment can also be used. For one example, the print media substrate can be passed between a pair of rollers, as part of a calendering process, after drying. The calendering device can be any kind of calendaring apparatus, including but not limited to off-line super-calender, on-line calender, soft-nip calender, hard-nip calender, or the like.

In further detail and by way of example, a textile or paper substrate can be modified on single or both sides with the coating composition. The coating composition can form a coating that is at the outermost surface of the print media, such that the coating is an ink-receiving layer when ink is printed on the media. In certain examples, a primary layer can be formed on the substrate first, followed by an ink-receiving layer formed over the primary layer. In such examples, the primary layer and the ink-receiving layer can both be coating compositions as described herein. In specific examples, the primary layer can be formed from a coating composition that includes inorganic filler particles and the ink receiving layer can be formed from a coating composition that does not include inorganic filler particles. Both the primary and the ink-receiving layers can include phosphonium-containing polyurethane polymer. In various examples, the primary layer, ink-receiving layer, or both can be formed on one side or both sides of the media.

In one example, the ink-receiving layer can be formed on a print media substrate with a dried coating weight from 0.3 grams/m² (gsm) to 50 gsm, from 0.5 gsm to 30 gsm, from 0.8 gsm to 20 gsm, from 0.5 gsm to 10 gsm, from 0.8 gsm to 10 gsm, from 0.8 gsm to 5 gsm, from 0.8 gsm to 3 gsm, from 1 gsm to 15 gsm, from 1 gsm to 1 gsm, or from 1 gsm to 5 gsm. The primary coating layer can be formed with a dried coating weight from 0 gsm to 40 gsm, from 0.5 gsm to 30 gsm, from 0.8 gsm to 20 gsm, from 0.5 gsm to 10 gsm, from 0.8 gsm to 10 gsm, from 0.8 gsm to 5 gsm, from 0.8 gsm to 3 gsm, from 1 gsm to 15 gsm, from 1 gsm to 1 gsm, or from 1 gsm to 5 gsm. The coatings of the present disclosure can be applied with varying degrees of smoothness, as well as to provide the ability of the coated media to absorb ink or to evenly distribute ink colorant, e.g., pigment.

The coating compositions described herein can be suitable for use with many types of print media, including paper, fabric, plastic, e.g., plastic film, metal, e.g., metallic foil, and other types of printable substrates, including combinations and/or composites thereof. In particular, textiles or fabrics can be treated with the coating compositions of the present disclosure, including cotton fibers, treated and untreated cotton substrates, polyester substrates, nylons, blended substrates thereof, etc. It is notable that the term “fabric substrate” or “fabric print media substrate” does not include print media substrate materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., KEVLAR® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of each fiber type can vary. For example, the amount of the natural fiber can vary from 5 wt % to 95 wt % and the amount of the synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of the synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

The basis weight of the print media, such as the paper, fabric, plastic film, foil, etc., can be from 20 gsm to 500 gsm, from 40 gsm to 400 gsm, from 50 gsm to 250 gsm, from 50 gsm to 400 gsm, or from 75 gsm to 150 gsm, for example. Some print media substrates can be toward the thinner end of the spectrum, and other print media substrates may be thicker, and thus, the weight basis ranges given are provided by example, and are not intended to be limiting.

Regardless of the print media substrate used, such substrates can contain or be coated with additives including, but not limited to, colorant (e.g., pigments, dyes, and tints), antistatic agents, brightening agents, nucleating agents, antioxidants, UV stabilizers, and/or fillers and lubricants, for example. Alternatively, the print media substrates may be pre-treated in a solution containing the substances listed above before applying other treatments or coating layers

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a weight ratio range of about 1 wt % to about 20 wt % should be interpreted to include the explicitly recited limits of about 1 wt % and about 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Aliphatic Phosphonium Salt-Based Diol

Dihydroxylpropyltributylphosphonium chloride salt (TBPDHPCl) was prepared in accordance with Formula 1, and as further described below:

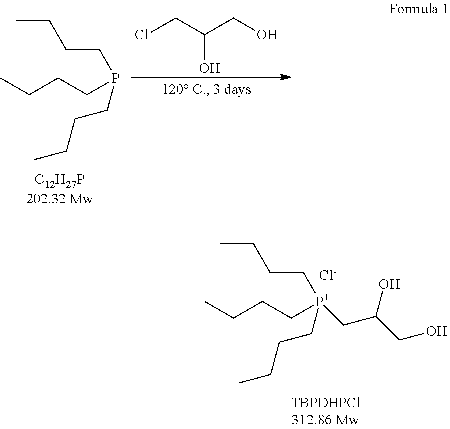 [SMILES: CCCCP(CCCC)CCCC ; OCC(O)CCl ; CCCC[P+](CCCC)(CCCC)CC(O)CO ; [Cl-]]

In accordance with Formula 1, a 500 mL four-necked flask equipped with a mechanical stirrer, a thermometer, a dropping funnel, and a condenser was purged with nitrogen, and 150 g (0.741 mol) of tri-n-butylphosphine was added. At 80° C., 86.11 g (0.779 mol) of 1-chloro-2,3-propanediol was added dropwise over 30 minutes, and the solution turned white and cloudy. The solution continued to be heated to 120° C. for 2 days under nitrogen and stirring. The reaction solution was a viscous, colorless, and transparent liquid. The presence of unreacted trialkylphosphine was tested using carbon disulphide, but trialkylphosphine was not detected. The solution was concentrated using an evaporator and then dried with a vacuum pump to give 226.03 g of a colorless and transparent viscous liquid. The titration purity was 100.0% and the yield was 97.5 wt %.

### Example 2—Preparation of Polyurethane Dispersion 1 (D1)

A polyurethane dispersion was prepared having polyalkylene oxide and aliphatic phosphonium salt side chain pendant groups. In this example, 69.310 g of polyester diol (Stepanpol PC-1015-55), 11.644 g of 1,6-hexamethylene diisocyanate (HDI), 11.715 g of polyalkylene oxide diol YMER™ N-120 (Mw=1000) (available from Perstorp, Sweden), 7.331 g of dihydroxylpropyl tributylphosphonium chloride (TBPDHPCl), and 90 g of acetone were mixed in a 500 mL of 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. The polymerization temperature was reduced to 50° C. and then 209.5 g of deionized water was added over 20 minutes. The solution became milky and white in color and the milky dispersion was continuously stirred overnight at room temperature. The polyurethane dispersion was filtered through a 400 mesh stainless sieve. Acetone was removed with a Rotorvap at 50° C. (add 2 drops (20 mg) BYK-011 de-foaming agent). The final polyurethane dispersion was filtered through fiber glass filter paper. The particle size of the polyurethane particle was measured by Malvern Zetasizer at 59.8 nm. The pH of the dispersion was 7.5. The solids content was 31.76 wt %. The acid number was 0 mg KOH/g.

### Example 3—Preparation of Polyurethane Dispersion 2 (D2)

Another example polyurethane dispersion was prepared with a different proportion of phosphonium salt groups. In this example, 54.194 g of polyester diol (Stepanpol PC-1015-55), 13.879 g of 1,6-hexamethylene diisocyanate (HDI), 20.973 g of polyalkylene oxide diol YMER™ N-120 (Mw=1000) (available from Perstorp, Sweden), 10.936 g of dihydroxylpropyltributylphosphonium chloride (TBPDHPCl) and 90 g of acetone were mixed in a 500 mL of a 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. The polymerization temperature was reduced to 50° C. and then 209.5 g of deionized water was added over 20 minutes. The solution became milky and white in color and the milky dispersion was continuously stirred overnight at room temperature. The polyurethane dispersion was filtered through a 400 mesh stainless sieve. Acetone was removed with a Rotorvap at 50° C. (add 2 drops (20 mg) BYK-011 de-foaming agent). The final polyurethane dispersion was filtered through fiber glass filter paper. The particle size of the polyurethane particle was measured by Malvern Zetasizer at 69.1 nm. The pH of the dispersion was 7.0. The solids content was 34.68 wt %. The acid number was 0 mg KOH/g.

### Example 4—Preparation of Polyurethane Dispersion 3 (D3)

A third polyurethane dispersion was prepared with a different proportion of phosphonium salt groups. In this example, 31.828 g of polyester diol (Stepanpol PC-1015-55), 17.230 g of 1,6-hexamethylene diisocyanate (HDI), 24.671 g of polyalkylene oxide diol YMER™ N-120 (Mw=1000) (available from Perstorp, Sweden), 16.271 g of dihydroxylpropyltributylphosphonium chloride (TBPDHPCl) and 90 g of acetone were mixed in a 500 mL of a 4-neck round bottom flask. A mechanical stirrer with glass rod and Teflon blade was attached. A condenser was attached. The flask was immersed in a constant temperature bath at 75° C. The system was kept under a drying tube. 3 drops of bismuth catalyst (Reaxis C3203) was added to initiate the polymerization. Polymerization was continued for 3 hours at 75° C. 0.5 g samples were withdrawn for % NCO titration to confirm the reaction. The polymerization temperature was reduced to 50° C. and then 209.5 g of deionized water was added over 20 minutes. The solution became milky and white in color and the milky dispersion was continuously stirred overnight at room temperature. The polyurethane dispersion was filtered through a 400 mesh stainless sieve. Acetone was removed with a Rotorvap at 50° C. (add 2 drops (20 mg) BYK-011 de-foaming agent). The final polyurethane dispersion was filtered through fiber glass filter paper. The particle size of the polyurethane particle was measured by Malvern Zetasizer at 157.2 nm. The pH of the dispersion was 7.0. The solids content was 24.46 wt %. The acid number was 0 mg KOH/g.

### Example 5—Preparation of Coating Compositions (F1-F4)

Four (4) coating compositions (F1-F4) were prepared. F1-F3 included the phosphonium-containing polyurethane particle dispersions D1-D3. F4 included a commercially available polymer dispersion, SANCURE® 2026 from Lubrizol Advanced Materials, Inc. (Ohio). F4 is a comparative composition because the SANCURE® 2026 is not a phosphonium-containing polyurethane. These coating compositions included the polyurethane particle dispersions, or SANCURE® 2026, in an amount of 11 wt %. The coatings also included 0.5 wt % of TECO® Wet 510 surfactant (Evonik, Germany); 6.5 wt % ARALDITE® PZ 3901 epoxy resin dispersion (Huntsman, Tex.); and 6.5 wt % ARADUR® 3985 curing agent (Huntsman, Tex.). The remainder of the compositions was water.

### Example 6—Coated Fabric Media

Coating compositions F1-F4 were independently applied at a coating weight basis of about 3 gsm onto a polyester fabric substrate having a plain weave and a substrate weight basis of about 130 gsm. The coating composition was applied using a lab Methis padder with the speed of 5 meters per minute. Then, the coated fabric was dried using an IR oven at a peak temperature of 120° C.

The coated fabric substrates were printed with a pigmented ink composition using an HP® L 360 printer available from HP, Inc. (USA). The coated and subsequently printed fabric substrates were evaluated for resistance to scratch, dry rub, wrinkle, fold, and flame resistance using a testing protocol referred to the NFPA 701 FR Test. The printed images were also evaluated for dark line, gamut, optical density (OD), and L*min.

The testing protocols for the data collected below as shown in Table 1 was as follows:
Wrinkle resistance was evaluated manually by multiple operators (n=5) by crinkling and holding the textile in hands for 1 minute and then placing the fabric samples flatly on a surface and evaluating the degree of wrinkle. Scores ranging from 1 to 4 were used, with 4 indicating the best performance (insignificant wrinkling), 1 indicating the worst performance, and a score of 3 was considered passing.
Dark Line testing was carried out for visual inspection under lighting. The sample is prepared by folding printed fabric three turnings and placing a 5 pound weight on top of the folded fabric for 10 minutes. The sample is then viewed under back-lighting.
Fold testing is similar to dark line testing. The sample is folded in the same way, but then the sample is viewed under reflective lighting instead of back lighting.
Dry Rub resistance was tested by using an abrasion scrub tester. For this test, the fabrics were printed with available colors, e.g., cyan, magenta, yellow, and/or others). A weight of 250 g was loaded on a test header. The test tip made of acrylic resin with crock cloth was used. The device was set to move the tip at 25 cm/min for a total of 8 inches, cycled 5 times. The test probe was evaluated in dry (dry rub) mode. The ink transferred to the test cloth was evaluated visually. Scores ranging from 1 to 4 were used, with 4 indicating the best performance, 1 indicating the worst performance, and a score of 3 was considered passing.
Scratch testing was carried out using a coin to scratch the ink printed on the coated fabric substrates. Scratch testing was carried out on the printed fabrics using all available colors (cyan, magenta, yellow, and any others available). The samples were subjected to a scratch testing by a coin-like test header which was 45 degrees facing the surface of the tested samples. Scratching under a normal force of 800 g was used. The test was done in a BYK Abrasion Tester (from BYK-Gardner, USA) with a linear, back-and-forth action, attempting to scratch off the image side of the samples (5 cycles). The image durability was evaluated visually. Scores ranging from 1 to 4 were used, as indicated at the bottom of Table 1. “MD” refers to machine direction, in which the fabric weaving direction is parallel to the movement of the test header. “CMD” refers to cross machine direction, in which the fabric weaving direction is perpendicular to the movement of the test header.
Gamut was measured using a MACBETH® TD904 (Macbeth Process Measurement) machine.
Optical Density (OD) was measured using a X Rite 938 Spectro Densitometer. L*min was measured using a X Rite 938 Spectro Densitometer.

TABLE 1
Image Quality and Durability on Fabric Substrates
with Coating Compositions F1-F4

| | | Dark | | Dry | Scratch | Scratch | | | |
|---|---|---|---|---|---|---|---|---|---|
| ID | Wrinkle | Line | Fold | Rub | Test MD | Test CMD | Gamut | OD | L* Min |
| F1 | 4 | 5 | 4 | 5 | 3 | 5 | 497K | 1.8 | 12.5 |
| F2 | 4 | 4 | 5 | 4 | 3 | 5 | 489K | 1.8 | 13.5 |
| F3 | 5 | 4 | 4 | 5 | 4 | 5 | 487K | 1.8 | 12.0 |
| F4 | 4 | 3 | 4 | 3 | 4 | 5 | 474K | 1.6 | 14.0 |

For Visual Scoring: 1 = Fail; 2 = Marginal; 3 = Pass; 4 = Excellent

Flame retardance or resistance is evaluated based on NFPA 701 standard (Standard Methods of Fire Tests for Flame Propagation of Textiles and Films). This methodology measures ignition resistance of a fabric after it is exposed to a flame for 12 seconds, and then the flame, char length, and flaming residue are recorded, with “passing” criteria based on a total weight loss less than 40 w % after burning, and a burning time of residual drops at less than 2 seconds. “Residual drops” refer to the melted burning drops from the fabric substrate that occur during the burning test when the samples are handled vertically. The flame retardance test results are shown in Table 2.

TABLE 2
Flame Retardance Test Results of Fabric Substrates
with Coating Compositions F1-F4

| Coating ID | Weight Loss (%) | Residual Drops (s) |
|---|---|---|
| F1 | 34.5 | 9.1 |
| F2 | 21.6 | 3.3 |
| F3 | 9.9 | 2.0 |
| F4 | 63.1 | 24.1 |

As can be seen by the data collected in Table 2, the inclusion of the aliphatic phosphonium salt, e.g., cationic trialkylphosphonium salt, can provide enhanced flame-resistance to polyurethane particles on the fabric substrates. Increasing the amount of phosphonium salt groups in the polyurethane polymer appears to reduce the weight loss and residual drop burning time in the flame retardance tests. Furthermore, the coatings that included the phosphonium-containing polyurethane polymer had good image quality and durability.

What is claimed is:

1. A phosphonium-containing polyurethane composition, comprising:
an aqueous liquid vehicle; and
polyurethane particles comprising a polyurethane polymer devoid of end cap groups, the polyurethane polymer also including a polyurethane backbone having side chain groups along the polyurethane backbone, wherein the side chain groups collectively include aliphatic phosphonium salts and polyalkylene oxide groups.

2. The phosphonium-containing polyurethane composition of claim 1, wherein the aliphatic phosphonium salts include a trialkylphosphonium salt with three alkyl groups independently including a C1 to C5 straight or branched carbon chain.

3. The phosphonium-containing polyurethane composition of claim 1, wherein the polyalkylene oxides include polyethylene oxides, polypropylene oxides, or a combination thereof.

4. The phosphonium-containing polyurethane composition of claim 3, wherein the polyalkylene oxides independently have a number average molecular weight from 500 Mn to 15,000 Mn.

5. The phosphonium-containing polyurethane composition of claim 1, wherein the polyurethane polymer has a number average molecular weight from 3,000 Mn to 500,000 Mn.

6. The phosphonium-containing polyurethane composition of claim 1, wherein the polyurethane particles have an average particle size of from 25 nm to 3 μm.

7. The phosphonium-containing polyurethane composition of claim 1, wherein the polyurethane backbone comprises polymerized monomers including diisocyanates and diols, wherein the diols collectively comprise the aliphatic phosphonium salts and polyalkylene oxide groups.

8. The phosphonium-containing polyurethane composition of claim 7, wherein the diisocyanates include 2,2,4-trimethylhexane-1,6-diisocyanate; 2,4,4-trimethylhexane-1,6-diisocyanate; hexamethylene diisocyanate; methylene diphenyl diisocyanate; isophorone diisocyanate; 1-Isocyanato-4-[(4-isocyanatocyclohexyl)methyl]cyclohexane; or a combination thereof.

9. A coating composition, comprising:
an aqueous liquid vehicle including water and a surfactant;
a polymeric binder; and
polyurethane particles comprising a polyurethane polymer devoid of end cap groups, the polyurethane polymer also including a polyurethane backbone having side chain groups along the polyurethane backbone, wherein the side chain groups collectively include aliphatic phosphonium salts and polyalkylene oxide groups.

10. The coating composition of claim 9, wherein the polymeric binder comprises polyacrylate, polyurethane, vinyl-urethane, acrylic urethane, polyurethane-acrylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof.

11. The coating composition of claim 9, wherein the polymeric binder comprises an epoxy resin and wherein the coating composition further comprises a curing agent.

12. The coating composition of claim 9, wherein the aliphatic phosphonium salts include a trialkylphosphonium salt with three alkyl groups independently including a C1 to C5 straight or branched carbon chain; and wherein the polyalkylene oxides include polyethylene oxides, polypropylene oxides, or a combination thereof independently having a number average molecular weight from 500 Mn to 15,000 Mn.

13. A coated fabric medium, comprising:
a fabric substrate; and
a coating on a surface of the fabric substrate, the coating comprising a polyurethane polymer devoid of end cap groups, the polyurethane polymer also including a polyurethane backbone having side chain groups along the polyurethane backbone, wherein the side chain groups collectively include aliphatic phosphonium salts and polyalkylene oxide groups.

14. The coated fabric medium of claim 13, wherein the aliphatic phosphonium salts include a trialkylphosphonium salt with three alkyl groups independently including a C1 to C5 straight or branched carbon chain; and wherein the polyalkylene oxides include polyethylene oxides, polypropylene oxides, or a combination thereof independently having a number average molecular weight from 500 Mn to 15,000 Mn.

15. The coated fabric medium of claim 13, wherein the coating further comprises a polymeric binder that includes polyacrylate, polyurethane, vinyl-urethane, acrylic urethane, polyurethane-arcylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof.
